(19) United States
(12) Patent Application Publication
(10) Pub. No.: US 2005/0237771 A1
(43) Pub. Date: Oct. 27, 2005

(54) Circuit for converting an AC voltage to a DC voltage

(75) Inventors: Felix Franck, Munchen (DE); Peter Niedermeier, Munchen (DE)

Correspondence Address: OSRAM SYLVANIA INC, 100 ENDICOTT STREET, DANVERS, MA, 01923, US

(73) Assignee: PATENT-TREUHAND-GESELLSCHAFT FUR ELEKTRISCH GLUHLAMPEN MBH, MUNCHEN (DE)

(21) Appl. No.: 11/111,702

(22) Filed: Apr. 22, 2005

(30) Foreign Application Priority Data
Apr. 22, 2004 (DE) 102004019589.7

(51) Int. Cl. H02M 5/42

(52) U.S. Cl. 363/84

(57) ABSTRACT

Circuit for converting an AC voltage to a DC voltage in which a full-bridge rectifier is replaced by two controlled switches. An inductor is connected upstream such that power factor correction is also made possible for the rectifying function. The circuit has a mid-voltage at the output. As a result, a square-wave load current can be generated with the aid of two further switches.

### FIELD OF THE INVENTION

The invention relates to circuits for converting an AC voltage to a DC voltage. One advantageous embodiment of the invention includes power factor correction, referred to below as PFC.

### BACKGROUND OF THE INVENTION

A source supplies an AC input voltage and an alternating input current to a load. The source is, for example, a system voltage source having a frequency of 50 Hz. If the intention is to provide a DC voltage, the use of a full-bridge rectifier comprising four rectifier diodes is generally conventional. Such a circuit initially produces a pulsating DC voltage. This pulsating DC voltage can be smoothed using a smoothing capacitor. However, the smoothing capacitor brings about a pulsed current consumption from the AC voltage source. This results in a power factor which is considerably lower than 1. In order to remedy this, in particular in order to adhere to relevant specifications such as IEC 61000-3-2, PFC circuits are known.

Conventional PFC circuits are, for example, step-up converters, step-down converters, step-down half- and full-bridges as well as Cuk, Sepic and Zeta converters.

The above-described full-bridge rectifier generates a power loss which is dependent on a forward voltage of the rectifier diodes and the alternating input current. Since the forward voltage of the diodes depends on the semiconductor material used, the power loss of the full-bridge rectifier must be accepted. This is particularly disadvantageous in the case of devices which do not contain a fan, since the power loss leads to high temperatures of the components used. Operating devices for lamps typically do not have a fan.

A further disadvantage of the prior art described is the number of switches which are required in order to provide a DC voltage, in particular if PFC is required. The switches are generally implemented by semiconductor switches, diodes also being understood to be switches. Furthermore, transistors, such as MOSFETs, bipolar transistors and IGBTs, are controlled switches which can be switched on and off via a control signal.

### SUMMARY OF THE INVENTION

The object of the present invention is to propose a circuit for converting an AC voltage to a DC voltage, which has a lower power loss than a circuit having a full-bridge rectifier.

A further object of the invention is to make possible the abovementioned circuit with a lower number of switches than that in the prior art. This is particularly the case even if PFC is implemented.

This object is achieved by the following basic embodiment of a circuit according to the invention: The full-bridge rectifier is dispensed with, and for this reason the circuit contains a series circuit comprising at least two controlled switches. The smoothing capacitor is split into two series-connected storage capacitors. The source supplies to the connection points between the controlled switches and the storage capacitors via an inductance. The series circuits comprising switches and storage capacitors are connected in parallel. The desired DC voltage can be tapped off at this parallel circuit.

In comparison with the full-bridge rectifier having 4 diodes, the basic embodiment described of a circuit according to the invention has only 2 controlled switches. The number of switches is thus lower than in the prior art.

Furthermore, the power loss compared with that in the prior art is reduced by two improvements. The alternating input current flows through 2 switches in the case of a full-bridge rectifier, whereas it only flows through one switch in the basic embodiment of the circuit according to the invention. In addition, the switches in the full-bridge rectifier are diodes, whereas, according to the invention, controlled switches are used which bring about fewer losses.

The switches are switched on and off alternately. If the following switch control is used, the circuit according to the invention implements PFC: In accordance with a definition of the positive flow direction of the alternating input current, the switching-on of one switch brings about an increasing alternating input current, whereas the switching-on of the other switch brings about a falling alternating input current. The first-mentioned switch is now switched on until the alternating input current reaches an upper hysteresis value. The first-mentioned switch is then switched off, and the other switch is switched on until the alternating input current reaches a lower hysteresis value. The alternating input current is thus within a hysteresis band, the width of which can be selected. Note should be taken of the fact that a narrow hysteresis band brings about a high switching frequency for the switches. The hysteresis values are selected such that they are proportional to the AC input voltage. The waveform of the hysteresis band, and thus essentially the waveform of the alternating input current, thus corresponds to the waveform of the AC input voltage. In the ideal case, the circuit according to the invention can thus achieve the value 1 for the power factor. The fluctuations of the alternating input current which have a higher frequency than a system frequency can be damped by known filter circuits at the input of the circuit.

In the steady state, in each case a voltage which is at least as high as the peak value of the AC input voltage is applied to the storage capacitors. A stabilized center point having a mid-voltage is formed between the storage capacitors. This center point may advantageously be used for a load circuit which requires a square-wave AC voltage. For this purpose, the load circuit is connected with one connection to the center point, the voltage of one and the other storage capacitor alternately being applied to the other connection. This square-wave frequency, which is used to switch over between the storage capacitors, may be superimposed by higher-frequency switching. With the aid of an inductance in the load circuit, a load current can be regulated by means of the higher-frequency switching.

### BRIEF DESCRIPTION OF THE DRAWINGS

The invention will be explained in more detail below using exemplary embodiments and with reference to the drawings, in which:

FIG. 1 shows an exemplary embodiment of a circuit according to the invention,

FIG. 2 shows a waveform of AC input voltage, alternating input current and the voltage between the switches,

FIG. 3 shows an exemplary embodiment of a circuit according to the invention with 3-state implementation,

FIG. 4 shows a waveform of AC input voltage, alternating input current and the voltage between the switches in a 3-state implementation,

FIG. 5 shows an exemplary embodiment of a circuit according to the invention having a load circuit which contains a lamp,

FIG. 6 shows an exemplary embodiment of a circuit according to the invention having a load circuit with 3-state implementation, and

FIG. 7 shows a waveform of voltage and current of a load circuit in accordance with the exemplary embodiment in FIG. 6.

Below, switches are designated by the letter S, diodes by the letter D, capacitors by the letter C, connecting nodes by the letter N, inductors by the letter L and connections by the letter J, in each case followed by a number. In addition, the same references are used throughout below for identical elements and elements having identical functions in the various exemplary embodiments.

### DETAILED DESCRIPTION OF THE INVENTION

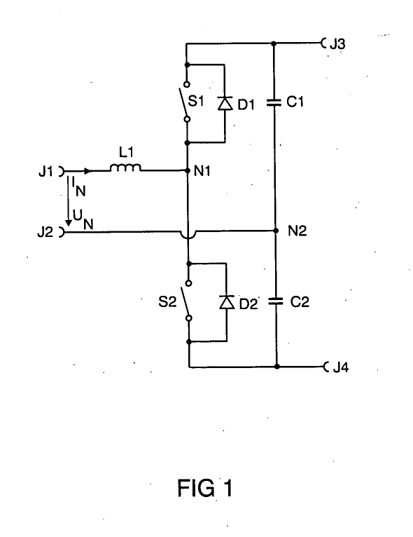

FIG. 1 shows an exemplary embodiment of a circuit according to the invention for converting an AC voltage UN to a DC voltage. The circuit has the following features:
a first and a second input terminal J1, J2 to which a source can be connected which can emit an AC input voltage UN and an alternating input current IN,
a first and a second output terminal J3, J4 to which a load can be connected,
a first and a second controlled switch S1, S2 which are connected in series between the output terminals J3, J4 and form a switch connecting node N1,
a first and a second storage capacitor C1, C2 which are connected in series between the output terminals J3, J4 and form a capacitor connecting node N2,
the first input terminal J1 is connected to the switch connecting node N1 via an inductor L1, and
the second input terminal J2 is connected to the capacitor connecting node N2.

In FIG. 1, in each case a generally known freewheeling diode D1 and D2 is connected in parallel with each switch S1 and S2. These diodes reduce the switch-on losses and are unnecessary for the embodiment of the invention. If MOSFETs are used as the switches, the freewheeling diodes are already in principle contained in the switch as a so-called body diode.

In FIG. 1, an inductance L1 is connected only between the input terminal J1 and the switch connecting node N1. However, another inductance may also be connected between the input terminal J2 and the capacitor connecting node N2. Of importance to the operation of the circuit is the sum of the values of the two inductances. The use of two inductances makes the circuit symmetrical, which results in an improvement in terms of radio interference. A further improvement is brought about by coupling the two inductances.

A control device (not shown) provides control signals which switch the switches alternately on and off. The ratio of switch-on time to switch-off time of the switches defines a duty cycle. The duty cycle can be used to set the value of the DC voltage which is provided between the output terminals J3 and J4. In the case of a “continuous mode” known from the prior art and a duty cycle of 50%, four times the maximal value of the AC input voltage is applied between the output terminals J3 and J4.

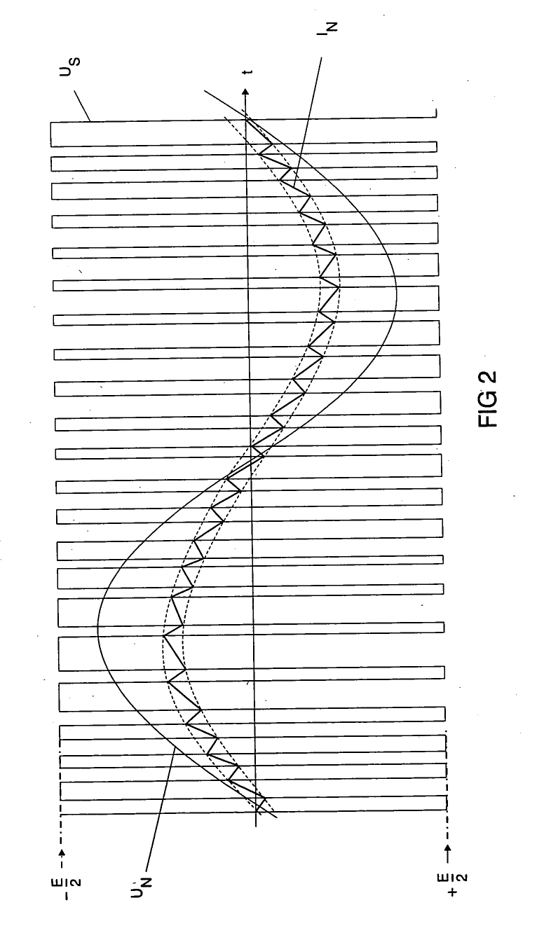

The circuit illustrated in FIG. 1 is also able to provide PFC. For this purpose, the switches must be switched as can be seen in FIG. 2.

The horizontal axis in FIG. 2 forms a time axis. A sinusoidal voltage UN is illustrated as the AC input voltage. The frequency of UN is, for example, 50 Hz. The switching state of the switches is given by the voltage US which represents the voltage between the switch connecting node N1 and the capacitor connecting node N2. If the switch S2 is closed, the voltage US is at an arbitrarily defined potential −E/2; if the switch S1 is closed, the voltage US is at an arbitrarily defined potential +E/2.

The waveform of the alternating input current IN is within a hysteresis band illustrated by dashed lines. As soon as the alternating input current IN reaches the limit of the predetermined hysteresis band, the respectively switched-on switch is switched off and the respectively switched-off switch is switched on. The switch to be switched on may also be switched-on in delayed fashion, since initially the associated freewheeling diode can take over the switch current.

The switching frequency of the switches is shown in FIG. 2 to be very low in comparison to the frequency of the AC input voltage UN in order to provide a clear illustration. It is clear that the waveform of the alternating input current IN essentially follows the waveform of the AC input voltage UN. PFC is thus achieved.

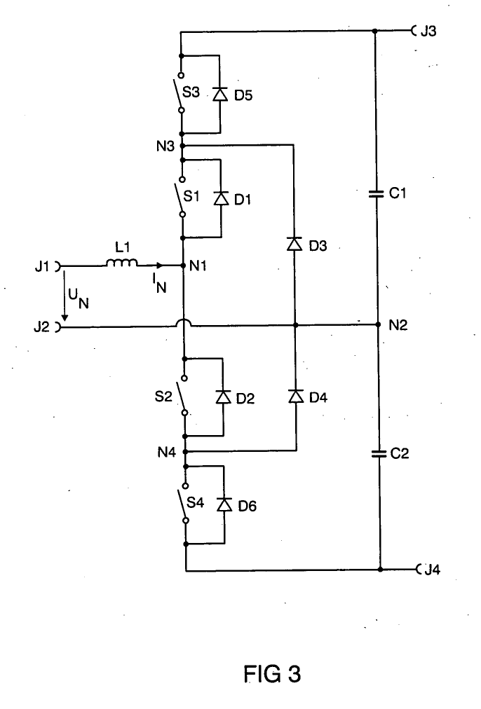

FIG. 3 shows a circuit which has been modified compared to that in FIG. 1. A switch S3 is connected in series with the switch S1, and a switch S4 is connected in series with the switch S2. As with the switches S1 and S2, a freewheeling diode D5 and D6 can also be connected in parallel with the switches S3 and S4. A third connecting node N3 lies between the switches S1 and S3, and a fourth connecting node N4 lies between the switches S2 and S4. The connecting nodes N3 and N4 are each connected to the capacitor connecting node N2 via a clamping diode D3, D4. Owing to the series circuit comprising the switches, a topology results which makes possible so-called multi-level or multi-state operation. This mode of operation is known from the prior art and is described, for example, in the following literature: T. Skvarenia: “The Power Electronics Handbook”, CRC Press, Boca Raton, Fla., USA, 2001; Chapter 6. FIG. 3 forms an application of this mode of operation to the circuit according to the invention shown in FIG. 1.

Multi-state operation reduces the voltage load on the switches. In FIG. 3, 3-state operation is possible which halves the voltage load on the switches. According to said literature reference, operation for more than 3 states is also known which can also be applied to the present invention. Characteristic of the 3-state operation is the fact that there are states in which S1 and S2 are closed and thus the voltage between N1 and N2 is zero.

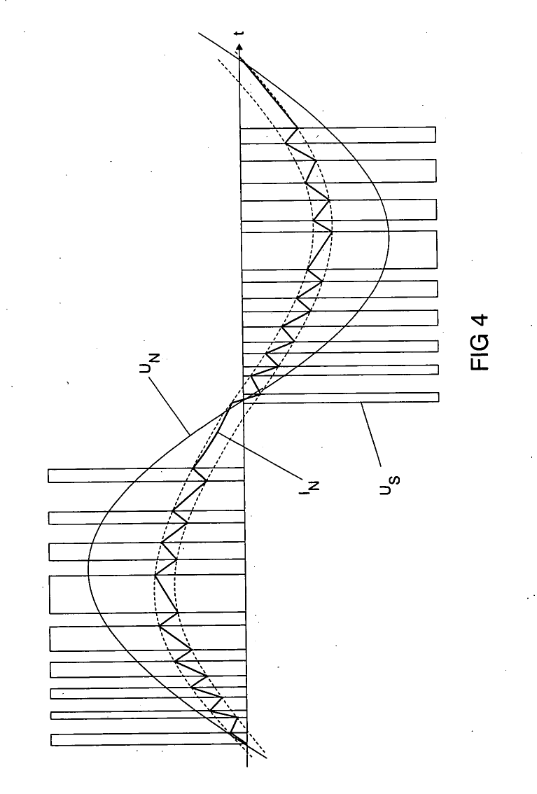

FIG. 4, in analogy to FIG. 2, shows the waveform of the AC input voltage UN, the alternating input current IN and the voltage US between N1 and N2 for 3-state operation. The waveform shows the respectively required switch position. The waveform of UN and IN is essentially congruent with the waveform illustrated in FIG. 2. However, the waveform of the voltage US is different. Given a positive AC input voltage UN, the voltage US has a minimum of zero. S1 may in this case always remain closed, and S2 and S3 close alternately. Given a negative AC input voltage UN, the voltage US has a maximum of zero. In this case, S2 may always remain closed, and S1 and S4 close alternately.

Particularly advantageous is the combination of a circuit according to the invention with a load which requires a mid-voltage, since the potential at the capacitor connecting node N2 is in the middle between the potentials of the output terminals J3 and J4. A mid-voltage is required if a load requires a square-wave voltage and the intention is to generate this voltage in a switch-saving manner using only 2 switches. The combination of a circuit according to the invention with such a load is also advantageous since the circuit according to the invention at least doubles the input voltage.

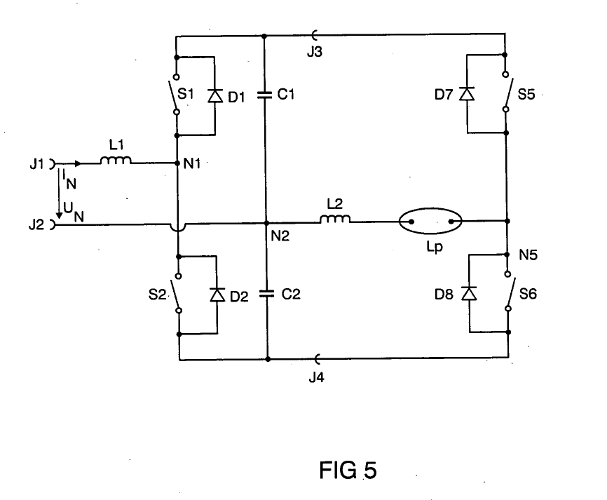

FIG. 5 shows an example of such a circuit. That part of the circuit which provides the DC voltage to J3 and J4 is known from FIG. 1. The series circuit comprising two switches S5 and S6 is connected between J3 and J4, the connecting node N5 being formed. The load is connected between N5 and N2. In the example, this load comprises a gas discharge lamp Lp and a lamp inductor L2.

Gas discharge lamps for alternating current are preferably operated using a square-wave alternating current. In the prior art, full-bridges are mainly used for this purpose. The circuit according to the invention allows the use of a half-bridge owing to the mid-point potential at N2.

The switches S5 and S6 are switched on and off at a desired square-wave frequency. The square-wave frequency may be superimposed by a higher frequency at which a switch which has just been switched on is also clocked. This clocking, together with the lamp inductor L2, leads to a step-down effect, as a result of which the lamp cur-rent can be regulated.

Freewheeling diodes D7 and D8 can be connected in parallel with S5 and S6. A capacitor, which makes possible compensation currents having a higher frequency than a system frequency, can be connected in parallel with the input terminals J1 and J2.

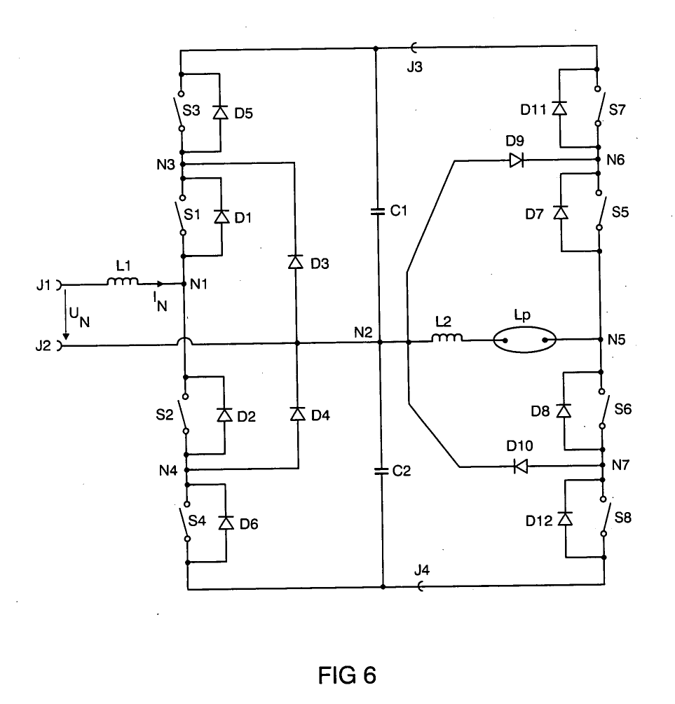

FIG. 6 illustrates the design not only of the input part with the switches S1-4 as a 3-state stage corresponding to FIG. 3 but also of the output part with the switches S5-8. The insertion of the switches S7 and S8 as well as the clamping diodes D9 and D10 can be derived from the above-cited literature for multi-state operation.

For operation of a gas discharge lamp with a square-wave voltage and PFC, an arrangement is known from the prior art which comprises 4 rectifier diodes, a step-up converter, a step-down converter and a full bridge. 10 switches are required for this purpose. Even the variant of the present invention which is illustrated in FIG. 6 has, with 8 switches, a lower number of switches than said prior art.

The output part may also have a higher number of states than 3, in accordance with the abovementioned literature reference for multi-state operation.

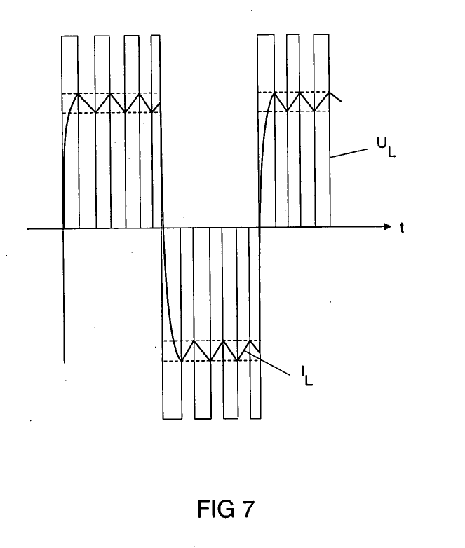

FIG. 7, in contrast to the waveforms shown in FIGS. 2 and 4, does not show input-side waveforms, but output-side waveforms. Waveforms are shown for the circuit shown in FIG. 6. UL shows the voltage waveform between the connecting nodes N5 and N2. IL shows the waveform of the load current IL through the lamp.

It can clearly be seen that the low-frequency square-wave voltage is superimposed by radiofrequency keying. The 3-state operation can be recognized by the fact that the voltage UL does not fluctuate between a maximum and minimum voltage but between a maximum voltage and a mid-voltage (horizontal axis) or between a minimum voltage and a mid-voltage (horizontal axis). The mid-voltage thus forms the third state.

A control apparatus (not shown) produces the control signals for the switches S5-S8. They are connected such that the load current IL waveform is in the predetermined hysteresis band illustrated by dashed lines.

1. A circuit for converting an AC voltage to a DC voltage having the following features:
a first (J1) and a second (J2) input terminal to which a source can be connected which can emit an AC input voltage (UN) and an alternating input current (IN), and
a first (J3) and a second (J4) output terminal to which a load can be connected,
characterized by the following features:
a first (S1) and a second (S2) controlled switch which are connected in series between the output terminals (J3, J4) and form a switch connecting node (N1),
a first (C1) and a second (C2) storage capacitor which are connected in series between the output terminals (J3, J4) and form a capacitor connecting node (N2),
the first input terminal (J1) is connected to the switch connecting node (N1) via an inductor (L1), and
the second input terminal (J2) is connected to the capacitor connecting node (N2).

2. The circuit as claimed in claim 1, characterized
in that a first freewheeling diode (D1) is connected in parallel with the first switch (S1), and a second freewheeling diode (D2) is connected in parallel with the second switch (S2).

3. The circuit as claimed in claim 1, characterized
in that the second input terminal (J2) is connected to the capacitor connecting node (N2) via a second inductor.

4. The circuit as claimed in claim 1, characterized in that the circuit comprises a control device which provides control signals for the switches (S1, S2),
the control signals causing the two switches (S1, S2) to switch on and off alternately,
and a duty cycle being selected between the switch-on duration and switch-off duration of the switches (S1, S2) such that the waveform of the alternating input current (IN) essentially follows the waveform of the AC input voltage (UN).

5. The circuit as claimed in claim 1, characterized by the following features:
a third switch (S3) is connected in series with the first switch (S1) and forms with it a third connecting node (N3),
a fourth switch (S4) is connected in series with the second switch (S2) and forms with it a fourth connecting node (N4),
a first clamping diode (D3) is connected between the capacitor connecting node (N2) and the third connecting node (N3), and
a second clamping diode (D4) is connected between the capacitor connecting node (N2) and the fourth connecting node (N4).

6. The circuit as claimed in claim 5, characterized
in that a third freewheeling diode (D5) is connected in parallel with the third switch (S3), and a fourth freewheeling diode (D6) is connected in parallel with the fourth switch (S4).

7. The circuit as claimed in claim 1, characterized by the following features:
a fifth (S5) and a sixth (S6) switch are connected in series between the output terminals (J3, J4) and form a fifth connecting node (N5), and
a series circuit comprising a gas discharge lamp (Lp) and a lamp inductor (L2) is connected between the capacitor connecting node (N2) and the fifth connecting node (N5).

8. The circuit as claimed in claim 7, characterized
in that a fifth freewheeling diode (D7) is connected in parallel with the fifth switch (S5), and a sixth freewheeling diode (D8) is connected in parallel with the sixth switch (S6).

9. The circuit as claimed in claim 7, characterized by the following features:
a seventh switch (S7) is connected in series with the fifth switch (S5) and forms with it a sixth connecting node (N6),
an eighth switch (S8) is connected in series with the sixth switch (S6) and forms with it a seventh connecting node (N7),
a third clamping diode (D9) is connected between the capacitor connecting node (N2) and the sixth connecting node (N6), and
a fourth clamping diode (D10) is connected between the capacitor connecting node (N2) and the seventh connecting node (N7).

10. The circuit as claimed in claim 9, characterized
in that a seventh freewheeling diode (D11) is connected in parallel with the seventh switch (S7), and an eighth freewheeling diode (D12) is connected in parallel with the eighth switch (S8).
